(19) United States
(12) Patent Application Publication
(10) Pub. No.: US 2020/0401102 A1
(43) Pub. Date: Dec. 24, 2020

(54) Frame Structure Optimization Method Based on 3D Printing

(71) Applicants: Qiang Cui, Guiyang (CN); Ming Zhang, Guiyang (CN); Chuan Yu, Guiyang (CN); Siddharth Suhas Pawar, Pune (IN)

(72) Inventors: Qiang Cui, Guiyang (CN); Ming Zhang, Guiyang (CN); Chuan Yu, Guiyang (CN); Siddharth Suhas Pawar, Pune (IN)

(21) Appl. No.: 16/531,132

(22) Filed: Aug. 5, 2019

(30) Foreign Application Priority Data
Jun. 21, 2019 (CN) 201910544553.6

(51) Int. Cl. G05B 19/4099; B33Y 50/00

(52) U.S. Cl. CPC G05B 19/4099; G05B 2219/49007; G05B 2219/35134; B33Y 50/00

(57) ABSTRACT

The invention disclosures a frame structure optimization method based on 3D printing, comprising following steps: a. inputting the information of force and material property of frame according to design requirement, and building an initial frame model by adopting generative design; b. conducting area reduction optimization for the initial frame model by using an edge contraction algorithm based on quadric error as metric cost, a simplification frame model is obtained; c. arranging point set in cavity of the simplification frame model, connecting each point in the point set, and calculating and retaining the most efficient point of distribution mode and connection mode in the point set based on a multi-objective optimization algorithm, deleting extra points, an optimization frame model is obtained; d. inputting tube radius, transforming the structure in the optimization frame model from the line to the body to obtain 3D printing model of the frame.

### BACKGROUND OF THE INVENTION

### 1. Field of the Invention

The invention relates to the field of 3D printing manufacturing technology, in particular to a frame structure optimization method based on 3D printing.

### 2. Background Art

In recent years, rapid molding manufacturing technology has developed rapidly, and new molding technologies represented by 3D printing have received wide attention worldwide. The core process of this technology is to melt wire or powder of material layer-by-layer in the form of a spherical powder or wire by high energy beams (including laser or electron beam) with the help of numerical control equipment, and then deposit to form large structural parts. Different from traditional “remove” cutting method, the technique is by the means of depositing layer by layer with the concept of “growth”, which may greatly improve the utilization rate of raw materials and the artistry of new products. Meanwhile, since a large number of mold design and processes are avoided, the preparation period of the components is greatly shortened and a large amount of input cost is saved. As a beneficial complement to the traditional molding methods of metal materials, 3D printing molding has solved many problems that cannot be overcome by thermal deformation preparation techniques.

The 3D printing mentioned above has many technical advantages, however, there are still many problems to be solved in actual application. For example, when using 3D printing to design and manufacture the frame, it is necessary to optimize the structure of the 3D printing to meet the corresponding printing requirements, therefore, how to efficiently and conveniently realize the structural optimization of the frame 3D printing has become an industry problem.

### SUMMARY OF THE INVENTION

The object of the invention is to provide a frame structure optimization method based on 3D printing. The invention has the advantageous effects of reducing material consumption, low cost and high structural strength.

The technical scheme of the invention: A frame structure optimization method based on 3D printing, comprising following steps:

a. inputting the information of force and material property of the frame according to design requirement, and building an initial frame model by adopting generative design;

b. conducting area reduction optimization for the initial frame model by using an edge contraction algorithm based on quadric error as metric cost, a simplification frame model is obtained;

c. arranging point set in the cavity of the simplification frame model, connecting each point in the point set, and calculating and retaining the most efficient point of distribution mode and connection mode in the point set based on a multi-objective optimization algorithm, deleting extra points, an optimization frame model is obtained;

d. inputting tube radius, transforming the structure in the optimization frame model from the line to the body to obtain 3D printing model of the frame.

The frame structure optimization method based on 3D printing mentioned above, wherein in step c, the method for arranging point set in the cavity of the simplification frame model: creating a bounding box for the simplification frame model, creating points in the bounding box randomly and uniformly, retaining points inside the cavity of the simplification frame model, and deleting points outside.

The frame structure optimization method based on 3D printing mentioned above, wherein in step c, when using the multi-objective optimization algorithm,

decision variables of the optimization: the longest connection distance of points, the shortest connection distance of points, maximum number of connections of points, random seed points for distributing points;

objective of optimization: the structure is with the shortest total length and the minimum strain energy.

The frame structure optimization method based on 3D printing mentioned above, wherein in step c, after obtaining the optimization frame model, analyzing the optimization frame model to obtain the maximum structural node displacement amount and strain energy; when the maximum structural node displacement amount and strain energy do not meet the design requirements, a new point set is created in the cavity of the simplification frame model by random selection, then calculating and retaining the most efficient point of distribution mode and connection mode in the point set based on a multi-objective optimization algorithm again, and finally until the maximum structural node displacement amount and strain energy in the optimization frame model structure may meet the design requirements.

### Advantageous Effects

Compared to the prior art, the invention builds an initial frame model by adopting generative design; through generative design, the design and construction of the frame model can rely on powerful cloud computing capabilities to generate thousands of designs in a short time; which may shorten the molding time, improve the molding efficiency, and also relying on the cloud computing can make more accurate and comprehensive calculation on the structure and strength of the constructed frame model, thereby the constructed frame model can achieve better structure and strength compared with the traditional method.

When optimizing the frame model, the invention is provided with point set base on complex frame model and the points are arranged to connect to each other; the multi-objective optimization algorithm adopted thereafter may simulate the foraging behavior of slime molds in nature for multi-objective optimization, in optimization, the intensive and efficient connection mode of points is retained, thereby meeting the 3D printing requirements of mechanical arm, reducing the material consumption and the manufacturing cost.

When using the Evolutionary Structural Optimization (ESO) to optimize the frame model, the applicant found that the obtained simplification frame model was too thin in some parts; if the model is used directly for 3D printing, the strength of these parts cannot meet the design requirements, and there are some details unnecessary and difficult to manufacture. In order to solve the problem, the applicant conducted many exploration and practice, and got inspiration from the foraging behavior of slime molds in nature, and finally found the method for solving the technical problem, that is: arranging point set in cavity of the simplification frame model, connecting each point in the point set, and calculating and retaining the most efficient point of distribution mode and connection mode in the point set based on a multi-objective optimization algorithm (in multi-objective optimization, the multi-objective optimization algorithm can search for efficient connection paths by selecting and confirming the decision variables and optimization targets, which is similar to the foraging behavior of slime molds.); in the method, by calculating the structural strength relationship of each point in the point set, the optimal solution of each point in the point set is finally obtained, and then the optimal model of the frame is obtained; according to the method, the final obtained optimization frame model is not only with high overall structural strength, also with the most simplified structure, thereby meeting the requirements of 3D printing manufacturing, while materials are saved to the maximum extent and the efficiency of 3D printing is improved.

In conclusion, the invention has the advantageous effects of reducing material consumption, low cost and high structural strength.

### BRIEF DESCRIPTION OF THE DRAWINGS

FIG. 1 is a flow chart of the invention;

FIG. 2 shows the initial frame model built by adopting generative design;

FIG. 3 shows the simplification frame model;

FIG. 4 shows the optimization frame model obtained by point set calculation;

FIG. 5 shows the final obtained frame 3D printing model.

### DETAILED DESCRIPTION OF THE PREFERRED EMBODIMENTS

The invention is further described below with reference to accompanying drawings and embodiments, and the description below can not be used as a basis to limit the invention.

### Embodiment 1

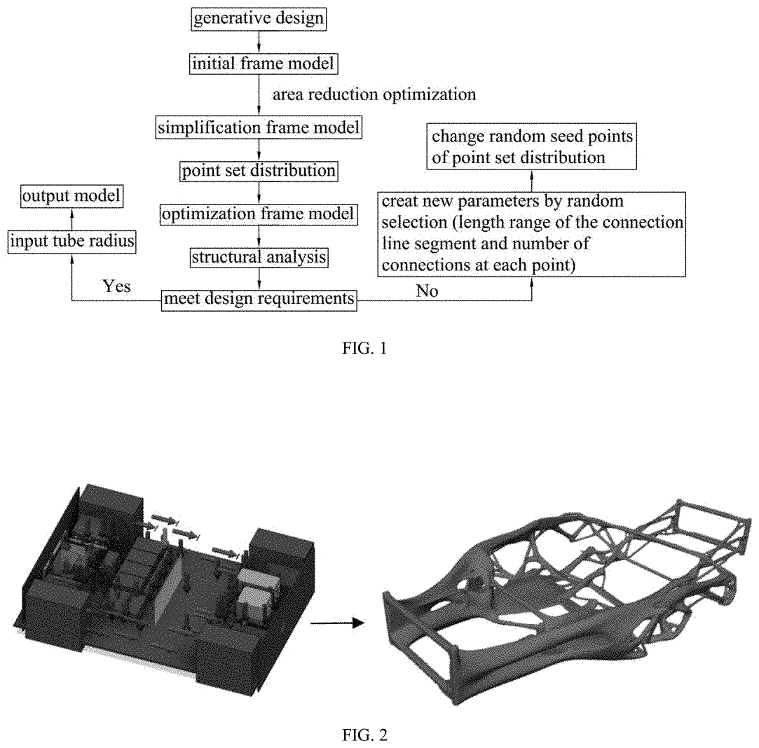

As shown in FIG. 1, a frame structure optimization method based on 3D printing, comprising following steps:

a. inputting the information of force and material property of the frame according to design requirement, and building an initial frame model by adopting generative design; specifically, as shown in FIG. 2, building the initial frame model by generative design software based on evolutionary structural optimization; through the generative design, the low-stress materials in the traditional frame structure are gradually removed, and the remaining structures are finally evolved into the optimal frame shape; the frame designed by the method has a more reasonable mechanical performance and saves material consumption. However, the frame structure designed by the method is more complex which can not be used directly for 3D printing and manufacturing, therefore, it is necessary to optimize the initial frame model;

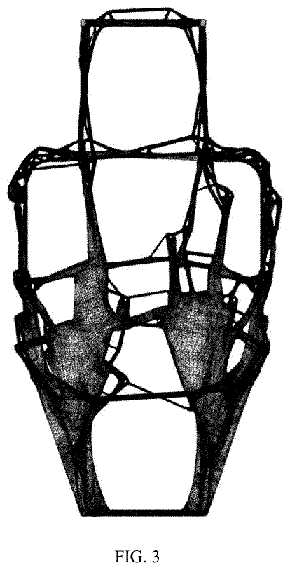

b. as shown in FIG. 3, conducting area reduction optimization for the initial frame model by using an edge contraction algorithm based on quadric error as metric cost, a simplification frame model is obtained; by conducting area reduction optimization for the initial frame model, the calculation complexity of subsequent processes can be reduced, which may improve the calculation efficiency; moreover, an edge contraction algorithm based on quadric error as metric cost is adopted to conduct area reduction optimization for the initial frame model in the invention, which not only has fast calculation speed and high calculation efficiency, but also can ensure the structural performance of the frame model remain the same after area reduction optimization, thereby making the overall performance quality of the model higher after area reduction optimization;

specifically, importing the initial frame model into the RHINO modeling software and using the reduceMesh command, that is, the area reduction optimization described in step b can be performed;

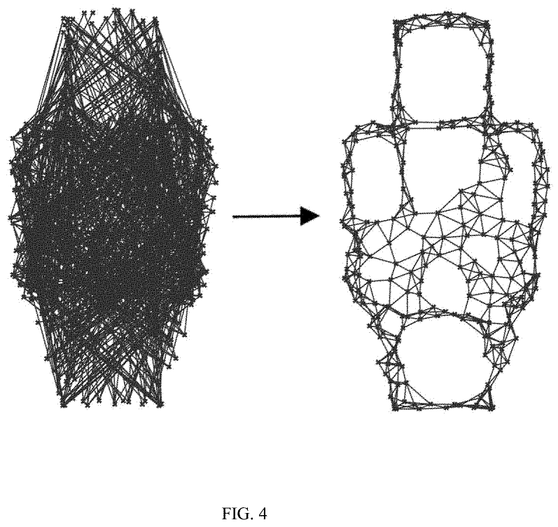

c. as shown in FIG. 4, arranging point set in the cavity of the simplification frame model, connecting each point in the point set, and calculating and retaining the most efficient point of distribution mode and connection mode in the point set based on a multi-objective optimization algorithm, deleting extra points, an optimization frame model is obtained; the most efficient point refers to the point which remain the least material consumption on the premise of satisfying the structural deformation quantity;

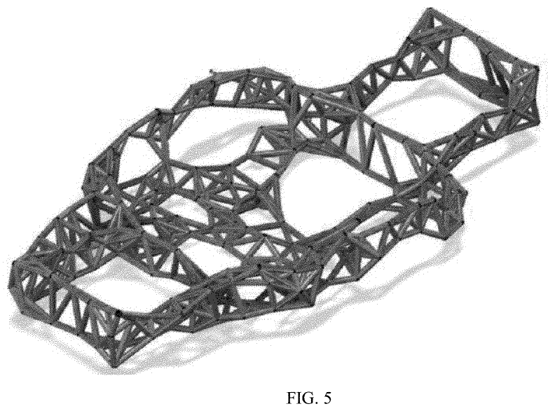

d. as shown in FIG. 5, inputting tube radius, transforming the structure in the optimization frame model from the line to the body to obtain 3D printing model of the frame.

Specifically, in step c mentioned above, the method for arranging point set in the cavity of the simplification frame model: creating a bounding box for the simplification frame model, creating points in the bounding box randomly and uniformly, retaining points in the cavity of the simplification frame model, and deleting points outside.

Specifically, in step c mentioned above, the calculation of multi-objective optimization algorithm specifically refers to conducting multi-objective optimization for the structure of the simplification frame model by adopting the multi-objective optimization algorithm; when optimizing,

decision variables of the optimization: the longest connection distance of points, the shortest connection distance of points, maximum number of connections of points, random seed points for distributing points;

objective of optimization: the structure is with the shortest total length and the minimum strain energy. The total length of the structure is the shortest, indicating the least consumption of production materials; the strain energy is the minimum, indicating the structure stability is the best.

Specifically, in step c mentioned above, after obtaining the optimization frame model, analyzing the optimization frame model (finite element analysis can be adopted) to obtain the maximum structural node displacement amount (that is, the maximum shape variable of the structure under stress) and strain energy; when the maximum structural node displacement amount and strain energy do not meet the design requirements (such as the maximum node displacement amount is required not exceed 20 mm in design requirement), a new point set is created in the cavity of the simplification frame model by random selection, then calculating and retaining the most efficient point of distribution mode and connection mode in the point set based on a multi-objective optimization algorithm again, and finally until the maximum structural node displacement amount and strain energy in the optimization frame model structure may meet the design requirements. Specifically, a new point set is created by random selection, firstly, creating new parameters, for example, length range of the connection line segment and number of connections at each point; and then, creating new point set by changing random seed points of point set distribution.

1. A frame structure optimization method based on 3D printing, comprising following steps:
a. inputting the information of force and material property of the frame according to design requirement, and building an initial frame model by adopting generative design;
b. conducting area reduction optimization for the initial frame model by using an edge contraction algorithm based on quadric error as metric cost, a simplification frame model is obtained;
c. arranging point set in the cavity of the simplification frame model, connecting each point in the point set, and calculating and retaining the most efficient point of distribution mode and connection mode in the point set based on a multi-objective optimization algorithm, deleting extra points, an optimization frame model is obtained;
d. inputting tube radius, transforming the structure in the optimization frame model from the line to the body to obtain 3D printing model of the frame.

2. The frame structure optimization method based on 3D printing of claim 1, wherein in step c, the method for arranging point set in the cavity of the simplification frame model: creating a bounding box for the simplification frame model, creating points in the bounding box randomly and uniformly, retaining points inside the cavity of the simplification frame model, and deleting points outside.

3. The frame structure optimization method based on 3D printing of claim 1, wherein in step c, when using the multi-objective optimization algorithm,
decision variables of the optimization: the longest connection distance of points, the shortest connection distance of points, maximum number of connections of points, random seed points for distributing points;
objective of optimization: the structure is with the shortest total length and the minimum strain energy.

4. The frame structure optimization method based on 3D printing of claim 1, wherein in step c, after obtaining the optimization frame model, analyzing the optimization frame model to obtain the maximum structural node displacement amount and strain energy; when the maximum structural node displacement amount and strain energy do not meet the design requirements, a new point set is created in the cavity of the simplification frame model by random selection, then calculating and retaining the most efficient point of distribution mode and connection mode in the point set based on a multi-objective optimization algorithm again, and finally until the maximum structural node displacement amount and strain energy in the optimization frame model structure may meet the design requirements.
